(19) United States
(12) Patent Application Publication
(10) Pub. No.: US 2020/0281188 A1
(43) Pub. Date: Sep. 10, 2020

(54) Avian Repellant Tape With Ultraviolet Patterning

(71) Applicant: Bird-B-Gone, Inc., Irvine, CA (US)

(72) Inventor: Bruce Donoho, Laguna Beach, CA (US)

(21) Appl. No.: 16/291,414

(22) Filed: Mar. 4, 2019

(51) Int. Cl. A01M 29/08; A01M 29/32; A01M 29/26; A01M 29/12; A01M 29/10

(52) U.S. Cl. CPC A01M 29/08; A01M 29/32; A01N 37/44; A01M 29/12; A01M 29/10; A01M 29/26

(57) ABSTRACT

An avian pest repellant device comprises an avian pest deterrent and an ultraviolet component. The device is preferably embodied as a tape that can be adhered to a window, to help prevent birds from flying into the window.

### FIELD OF THE INVENTION

The field of the invention is avian pest deterrence.

### BACKGROUND

The following description includes information that may be useful in understanding the present invention. It is not an admission that any of the information provided herein is prior art or relevant to the presently claimed invention, or that any publication specifically or implicitly referenced is prior art.

Avian pests perch in many places that can be problematic for humans, including for example, rooftops, ledges, and other areas on buildings and homes. Avian pests, such as birds, are associated with significant problems for humans including health hazards from exposure to bird droppings, unsightly messes from bird droppings, unwanted noise, property damage from roosting behaviors, and an undesirable physical presence of avian pests in human-occupied areas.

As the ultraviolet spectrum is visible to birds, attempts have been made to warn avian pests of transparent building materials without negatively affecting visibility in the human spectrum. For example, treatments on windows can include, as discussed further in the references below, markings that are only noticeable in the ultraviolet spectrum to warn birds away from flying through transparent building materials.

Additionally, attempts to deter avian pests have been made using chemical and physical deterrents. For example, methyl anthranilate is a known irritant to birds that has been used to deter birds from a particular space.

However, the use of ultraviolet markings to deter birds from surfaces has been limited to keeping birds from flying into transparent surfaces that birds misperceive as empty space. For example, ultraviolet marking are placed on vertical windows along the sides of buildings.

Additionally, the use of chemical and physical deterrents is dependent on the presence of the chemical and physical deterrent. If a chemical deterrent runs out, then avian pests are no longer deterred from entering the protected space. If a physical deterrent is broken or is otherwise removed, then avian pests can reoccupy the protected space.

U.S. Patent Application Publication No. 2009/0047487 to Klem teaches a clear or tinted window pane having a pattern on the surface of the pane created by ultraviolet light reflecting materials. U.S. Patent Application Publication No. 2015/0050505 to Arkles teaches the use of UV-absorbent coatings on window panes that create a pattern visible to birds in order to deter birds from flying into windows. Japanese Patent Application Publication No. 2017/001031 discloses the use of adhesive tapes containing a bird repellant, wherein the top and bottom sides of the adhesive tapes have different adhesive properties.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there remains a need for avian pest deterrents that employ chemical and/or physical deterrents in combination with ultraviolet markings to tie a negative physical effect to an easily recognizable pattern. It is contemplated that causing avian pests to negatively associate a marking with physical discomfort will discourage avian pests from landing in particular areas despite the absence of a chemical and/or physical deterrent.

### SUMMARY OF THE INVENTION

The inventive subject matter provides an avian repellant tape that comprises both avian deterrents and ultraviolet patterning to warn avian pests of the presence of avian deterrents.

Methyl anthranilate (C₈H₉NO₂) is an ester of anthranilic acid, and can be used to deter birds from an area by distributing gaseous MA into the area. MA is thought to irritate the mouth and lungs of birds that inhale the MA.

Physical deterrents include bird spikes and electric shock-based deterrents to create a hostile physical environment that deters birds from landing on one or more surfaces. For example, physical deterrent can include spikes that are spaced such that avian pests experience physical discomfort when roosting on the spikes. In other examples, electric shock-based deterrents can include pairs of electrical contacts that cause an electric current to travel through an avian pest's body when the avian pest roosts upon the electrical contacts.

The present invention contemplates the use of ultraviolet marking, which are not visible to humans but visible to birds, coupled with any one or more avian pest deterrents. In this way, avian pests are discouraged from roosting on surfaces with known deterrents by associated a particular ultraviolet patterning with the one or more avian pest deterrents. Combining avian pests deterrents with ultraviolet markings advantageously creates a negative (adverse) association between the ultraviolet marking and the avian pest deterrent, which discourages avian pests from landing on any surfaces with the same or similar patterning.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 depicts one embodiment of an avian pest repellant tape.

FIG. 2 depicts a top-down perspective view of the avian pest repellant tape.

FIG. 3 depicts a top down perspective view of a non-adhesive avian pest deterrent.

FIG. 4 depicts a top down perspective of a UV light emitting avian pest deterrent.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

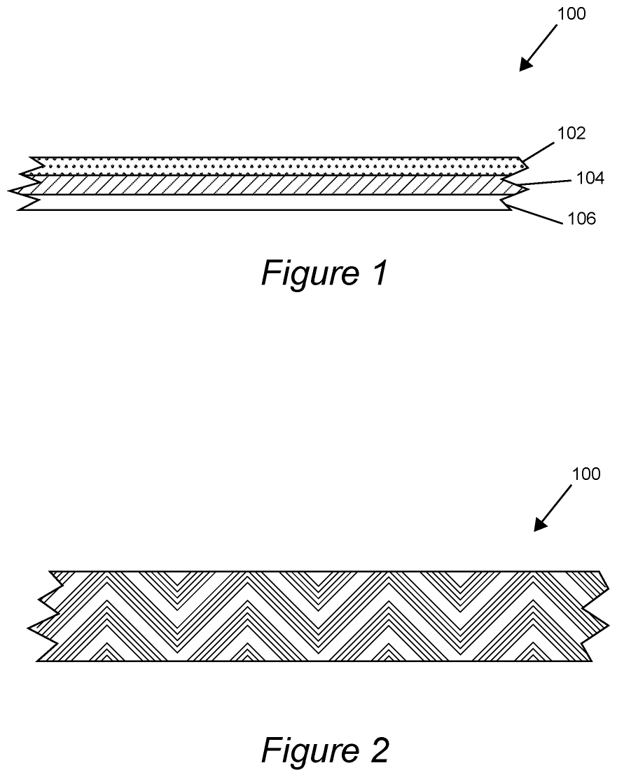

FIG. 1 depicts one embodiment of tape 100.

Tape 100 comprises top layer 102, middle layer 104, and bottom layer 106.

In preferred embodiments, top layer 102 comprises a chemical avian pest deterrent. Chemical avian pest deterrents can include, but are not limited to, methyl anthranilate and methyl 2-aminobenzoate.

It is contemplated that chemical avian pest deterrents can be incorporated into top layer 102 in any manner known in the art.

For example, methyl anthranilate can be suspended in a gel such that methyl anthranilate is off-gassed from top layer 102 in a controlled release. In another example, methyl anthranilate can be combined with additional elements into a powdered form and coupled to an adhesive top layer 102. In yet another example, top layer 102 can comprise cartridges filled with a concentrated liquid solution of one or more avian pest deterrents to be released via off-gassing.

In some embodiments, top layer 102 comprises a physical avian pest deterrent. For example, physical avian pest deterrents can include, but are not limited to, spikes, ridges, and any other physical formation that prevents or discourages birds from roosting on the surface.

In yet other embodiments, top layer 102 comprises chemical avian pest deterrents to achieve physical deterrence. For example, top layer 102 can comprise a highly sticky and viscous material that causes discomfort to avian pests and thereby discourages avian pests from roosting on the material.

Alternatively, top layer 102 can also comprise a combination of any one or more of a physical deterrent, a chemical deterrent, a sound-based deterrent, and an ultraviolet component. For example, top layer 102 can comprise bird spikes made of a UV reflecting material coated in methyl anthranilate. In another example, top layer 102 can comprise ultraviolet light reflecting material and electronic circuitry coupled to an electric shock-based deterrent.

In preferred embodiments, middle layer 104 comprises an ultraviolet component. It is contemplated that the ultraviolet component can comprise at least one of an ultraviolet light-absorbing material and an ultraviolet light-reflecting material.

For example, middle layer 104 can comprise a plastic sheet imprinted with a pattern formed by alternating ultraviolet light-absorbing and ultraviolet light-reflecting elements to create a pattern that is visible to bird without being distinguishable to humans.

It is further contemplated that middle layer 104 is preferably transparent, such that tape 100 is substantially transparent when every layer of tape 100 is substantially transparent. When tape 100 is substantially transparent, the original surface upon which tape 100 is applied is visible, which advantageously minimizes the appearance of the tape of surfaces in situations where aesthetic considerations are important.

In some embodiments, middle layer 104 can comprise a combination of elements that are visible to humans and invisible to humans. For example, middle layer 104 can comprise a pattern created by alternative ultraviolet reflecting material and a reflective red material. In alternative embodiments, middle layer 104 can comprise ultraviolet light emitting elements. For example, middle layer 104 can comprise a mesh of light emitting diodes (LED) that emit ultraviolet light. In this example, it is further contemplated that the mesh of LEDs can be attached to any one or more power sources. For example, middle layer 104 can be connected to any one or more of a battery, a solar-panel, and a wall outlet.

In some embodiments, tape 100 can be a non-adhesive combination of layers. For example, tape 100 can comprise only top layer 102 and middle layer 104. In this example, it is contemplated that top layer 102 comprises an avian pest deterrent and middle layer comprises ultraviolet components. Non-adhesive embodiments of tape 100 can be used in situations where tape 100 will lay on top of the surface without attachment means. Alternatively, non-adhesive embodiments of tape 100 can use alternative means of securing tape 100 to a surface. For example, tape 100 can alternatively be secure to a surface using screws, clips, and/or magnets.

FIG. 2 depicts a top-down perspective view of tape 100.

In the depicted embodiment, tape 100 comprises a pattern comprising UV reflecting materials and UV absorbing materials. It is contemplated that the pattern depicted is only one of many patterns that can be used.

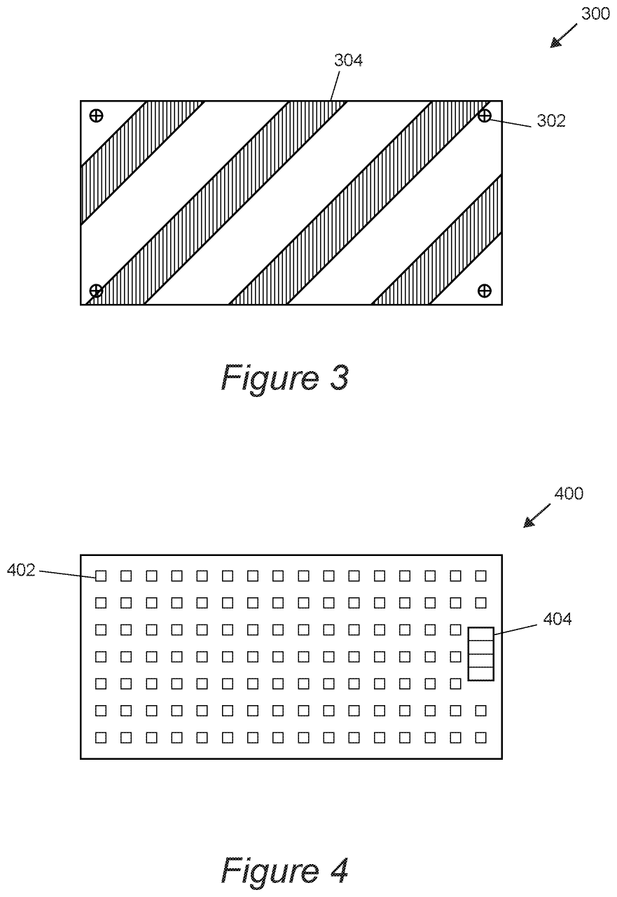

FIG. 3 depicts a top down perspective view of avian deterrent 300.

As depicted, avian deterrent 300 comprises coupling mechanism 302 and UV material 304.

Coupling mechanism 302 comprises any mechanism used to secure avian deterrent 300 to a surface. It is contemplated that coupling mechanisms can include, but are not limited to, fastener-based mechanisms, magnetic mechanisms, and suction-based mechanisms.

In a fastener-based example, coupling mechanism 302 can be a Phillips head screw that is drilled through a hold on avian deterrent 300 to secure avian deterrent 300 to a surface. In a magnetic example, coupling mechanism 302 can be a neodymium magnet that magnetically couples avian deterrent 300 to a ferrous surface. In a suction-based example, coupling mechanism 302 can be a suction cup that allows avian deterrent 300 to be secured to a non-porous surface (e.g., glass, plastics, etc.).

FIG. 4 depicts a top down perspective of a UV light emitting deterrent 400.

As depicted, UV light emitting deterrent 400 comprises a grid of UV LEDs 402 coupled to a power source 404. It is contemplated that UV light emitting deterrent 400 further comprises an avian pest deterrent. As discussed above, avian pest deterrents include any combination of deterrents, including, for example, chemical and physical deterrents.

In one embodiment, UV light emitting deterrent 400 comprises a layer above UV LEDs 402 that includes a chemical avian deterrent. For example, UV light emitting deterrent 400 can comprise a layer of viscous material saturated with methyl anthranilate for direct avian irritation or irritation of avian respiratory systems via off-gassing.

In another embodiment, UV light emitting deterrent 400 comprises a physical deterrent layered above UV LEDs 402. In another example, UV light emitting deterrent 400 can comprise a top layer of bird spikes that physically prevents birds from roosting on top of UV light emitting deterrent 400.

In yet another embodiment, UV LEDs 402 are incorporated into a physical deterrent. For example, UV LEDs 402 can be incorporated into clear plastic bird spikes, such that the clear bird spikes act as a conduit for light to diffuse over a larger surface area.

Power source 404 can be any combination of means used to power UV LEDs 402. In the depicted embodiment, power source 404 is a solar panel that delivers electricity to UV LEDs 402. It is also contemplated that the solar panel can deliver electricity to a rechargeable battery to be stored for later use.

In an alternative embodiment, power source 404 is connected to the electrical grid. For example, power source 404 can be a wall outlet that is electrically coupled to UV LEDs 404 via a combination of hardware elements.

It is further contemplated that power source 404 can comprise hardware that allows multiple UV light emitting deterrents to be electrically connected. For example, power source 404 can comprises electrical contacts that allow electricity to flow between two discrete UV light emitting deterrents 400 when physically coupled.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. An avian pest deterrent device, comprising:
an ultraviolet component; and
an stationary avian pest deterrent.

2. The avian pest deterrent device of claim 1, wherein the ultraviolet component is an ultraviolet light reflecting material.

3. The avian pest deterrent device of claim 1, wherein the ultraviolet component is an ultraviolet light absorbing material.

4. The avian pest deterrent device of claim 1, wherein the ultraviolet component is an ultraviolet light emitting material.

5. The avian pest deterrent device of claim 4, wherein the ultraviolet light emitting material comprises electronic circuitry and an ultraviolet light emitting diode.

6. The avian deterrent device of claim 1, wherein the avian pest deterrent in a physical deterrent.

7. The avian pest deterrent device of claim 6, wherein the physical deterrent is a bird spike.

8. The avian deterrent device of claim 1, wherein the avian pest deterrent is an electric shock-based deterrent.

9. The avian deterrent device of claim 1, wherein the avian pest deterrent is a chemical deterrent.

10. The avian pest deterrent device of claim 9, wherein the chemical avian pest deterrent is selected from the group consisting of: methyl anthranilate and methyl 2-aminobenzoate.

11. The avian pest deterrent device of claim 1, further comprising an adhesive.
